(19) United States
(12) Patent Application Publication
(10) Pub. No.: US 2026/0322097 A1
(43) Pub. Date: Oct. 15, 2026

(54) COMPOSITE CROSSARM

(71) Applicant: JIANGSU SHEMAR ELECTRIC CO., LTD., Nantong (CN)

(72) Inventors: Qing HUANG, Nantong (CN); Fa XIA, Nantong (CN)

(73) Assignee: JIANGSU SHEMAR ELECTRIC CO., LTD., Nantong (CN)

(21) Appl. No.: 18/723,976

(22) PCT Filed: Dec. 8, 2023
(86) PCT No.: PCT/CN2023/137411

§ 371 Date: Jun. 25, 2024

(30) Foreign Application Priority Data
Nov. 22, 2023 (CN) 202323168646.4

(51) Int. Cl. H02G 7/20

(52) U.S. Cl. CPC H02G 7/20

(57) ABSTRACT

A composite crossarm configured to be fixed on a pole to attach a conducting wire, includes a first crossarm. The first crossarm includes: a first rod; an intermediate fitting being a cross-shaped fitting, the intermediate fitting being connected to a middle portion of the first rod, configured to fix the first crossarm on the pole; two wire-attaching fittings respectively connected to two ends of the first rod, and configured to attach the conducting wire; and a first insulating layer covering at least part of an outer periphery of the first rod. The composite crossarm of the present disclosure has a simple overall structure, reliable strength, convenient mounting, and low manufacturing cost.

### CROSS-REFERENCE TO RELATED APPLICATIONS

This application is a national phase under 35 U.S.C. § 371 of PCT International Application No. PCT/CN2023/137411, which has an international filing date of Dec. 8, 2023 and claims priority of Chinese patent application No. 2023231686464, filed on Nov. 22, 2023, the contents of which is hereby incorporated by reference in its entirety.

### TECHNICAL FIELD

The present disclosure relates to the technical field of insulating crossarms, and in particularly, to a composite crossarm.

### BACKGROUND

A conventional composite crossarm generally has a main structure formed by a glass fiber pultruded tube, is filled with polyurethane foam, and coated with a special substance on the surface to prevent ultraviolet (UV) aging, which is not friendly to the environment. During mounting, the composite crossarm needs to be drilled, which reduces the strength of the composite crossarm, and results in a worrying service life. In addition, it is required that the composite crossarm is used in combination with porcelain insulators, which is inconvenient. The product structure is complex, the manufacturing cost is too high, and the price is expensive.

### SUMMARY

In view of the shortcomings of the conventional technology, an object of the present disclosure is to provide a composite crossarm to address the problems of the existing composite crossarm having a complex structure, low strength, and inconvenient mounting.

In order to achieve the above object, the technical means adopted in the present disclosure are as follows. A composite crossarm configured to be fixed on a pole to attach a conducting wire, includes a first crossarm. The first crossarm includes: a first rod; an intermediate fitting being a cross-shaped fitting, the intermediate fitting being connected to a middle portion of the first rod, configured to fix the first crossarm on the pole; two wire-attaching fittings respectively connected to two ends of the first rod, and configured to attach the conducting wire; and a first insulating layer covering at least part of an outer periphery of the first rod.

Preferably, the composite crossarm further includes a second crossarm. The first crossarm is fixed on the pole in a horizontal direction. The second crossarm is fixed on the pole in a vertical direction and is located above the first crossarm. The first crossarm and the second crossarm are separated from each other.

Preferably, the intermediate fitting includes an intermediate sleeve and a pole connecting member that are connected to each other. The intermediate sleeve fits over the middle portion of the first rod. The pole connecting member is vertically connected to the intermediate sleeve, and configured to fix the first crossarm to the pole.

Preferably, an inner wall of the intermediate sleeve is shaped and sized to match a cross section of the first rod.

Preferably, the pole connecting member includes two first connecting members. The two first connecting members are vertically connected in a middle portion of the intermediate sleeve, and are respectively located on two sides of the intermediate sleeve in a direction perpendicular to an axial direction of the intermediate sleeve. The first connecting member is configured to be connected to the pole.

Preferably, the first connecting member includes a first plate member and two second plate members. The first plate member is vertically connected to the two second plate members. The two second plate members extend from two ends of the first plate member in the same direction away from the first plate member. Ends of the two second plate members not connected to the first plate member are vertically connected to the intermediate sleeve. The second plate members are provided with first connecting holes respectively, and configured to be connected to the pole.

Preferably, the intermediate sleeve and the pole connecting member are connected to each other by a welding process or integrally formed by a casting process.

Preferably, a side of the intermediate sleeve adjacent to the pole is connected to at least two threaded rods. The pole connecting member includes a third plate member and a fourth plate member that are vertically connected to each other. The third plate member is provided with at least two second connecting holes. The threaded rods cooperate with the second connecting holes to connect the intermediate sleeve and the pole connecting member. The fourth plate member is provided with a plurality of third connecting holes and configured to be connected to the pole.

Preferably, the intermediate sleeve and the threaded rods are connected to each other by a welding process or integrally formed by a casting process. The third plate member and the fourth plate member are connected by a welding process.

Preferably, the wire-attaching fitting includes an end sleeve and a groove structure that are connected to each other. The end sleeve is configured to be connected to an end of the first rod. The groove structure is configured to attach the conducting wire.

Preferably, a first groove is provided on a top surface of the groove structure, and configured to receive the conducting wire. A second groove is circumferentially provided on a sidewall of the groove structure, and configured to assist in fixing the conducting wire. A lifting part is provided on a bottom of the groove structure, and configured to lift and mount the first crossarm.

Preferably, a cross section of the first rod is square.

Preferably, the first rod is formed by pultruding glass fiber or aramid fiber impregnated with epoxy resin.

Preferably, the fourth plate member includes a body connecting member and two connecting lugs having a same length as the body connecting member. The two connecting lugs are symmetrically connected to two sides of the body connecting member at a certain angle, to match a curvature of an outer periphery of the pole.

Preferably, the third connecting hole of the fourth plate member located above the third plate member is a combination hole. The combination hole is formed by partially intersecting a circular hole with a U-shaped hole. A diameter of the circular hole is greater than a width of the U-shaped hole.

Preferably, the groove structure includes a first groove and a lifting part that are arranged in an up-and-down sequence. The first groove is a U-shaped groove for receiving the conducting wire. A groove opening of the first groove is open upward. The lifting part is a C-shaped groove. A groove opening of the lifting part is open outward away from the first rod.

Preferably, the groove structure includes a cover, a tab, fasteners, and a first groove base. The first groove base is provided with a first groove, so as to receive the conducting wire. A second groove is provided on a bottom of the cover. The second groove is an arc-shaped groove, and configured to assist in fixing the conducting wire. The cover extends towards two sides in the axial direction of the first rod to form two tabs. The tabs and the first groove base are connected to each other through the fasteners, so that the cover is pressed against and fixes the conducting wire.

Preferably, the groove structure includes a support block, a locking component, and a first groove. A first end of the support block is connected to a second end of the end sleeve. One end of the first groove is connected to a second end of the support block. A side of the support block away from the end sleeve is provided with an adjustable groove. The adjustable groove is configured to cooperate with the locking component to fix the conducting wire.

Preferably, the locking component includes a locking bolt, a locking member, a locking plate, and a locking nut. The locking bolt extends through the locking plate and the adjustable groove, and is fixed in the adjustable groove through the locking nut. The locking member is capable of being moved along the locking bolt and performing locking, to fix the conducting wire between the locking member and the first groove.

Preferably, the locking member includes a moving block and a limiting block that are connected to each other. The moving block is provided with a moving hole to enable the locking member to move along the locking bolt and be locked by the locking nut. The limiting block is connected onto the outer periphery of the moving block. A side surface of the limiting block adjacent to the conducting wire is an arc surface.

The present disclosure has beneficial effects as follows. The composite crossarm of the present disclosure includes the first crossarm and the second crossarm that are separately from each other. The first crossarm includes the first rod, the intermediate fitting, the two wire-attaching fittings, and the first insulating layer. The composite crossarm has a simple overall structure, reliable strength, convenient mounting and low manufacturing cost. In addition, it is not necessary to drill holes in the first rod when the intermediate fitting of the present disclosure is connected to the first rod, which ensures the mechanical properties and load-bearing capacity of the composite crossarm, prolongs the service life of the composite crossarm, and reduces the overall cost.

### BRIEF DESCRIPTION OF THE DRAWINGS

FIG. 1 is a schematic perspective view of a power transmission pole 100 according to an embodiment of the present disclosure.

FIG. 2 is a schematic perspective view of an intermediate fitting 300 according to an embodiment of the present disclosure.

FIG. 3 is a schematic perspective view of a power transmission pole 100 according to another embodiment of the present disclosure.

FIG. 4 is a schematic perspective view of an intermediate sleeve 310 according to an embodiment of the present disclosure.

FIG. 5 is a schematic perspective view of a pole connecting member 320 according to an embodiment of the present disclosure.

FIG. 6 is a schematic perspective view of a wire-attaching fitting 400 for attaching a conducting wire according to an embodiment of the present disclosure.

FIG. 7 is a schematic perspective view of a wire-attaching fitting 400 for attaching a conducting wire according to another embodiment of the present disclosure.

FIG. 8 is a schematic perspective view of a wire-attaching fitting 400 for attaching a conducting wire according to yet another embodiment of the present disclosure.

FIG. 9 is a schematic perspective view of a wire-attaching fitting 400 for attaching a conducting wire according to still further embodiment of the present disclosure.

FIG. 10 is a schematic perspective view of the wire-attaching fitting 400 shown in FIG. 9.

FIG. 11 is a schematic perspective view of a locking member 4422 shown in FIG. 10.

FIG. 12 is a schematic perspective view of a fixing bracket 530 according to an embodiment of the present disclosure.

### DETAILED DESCRIPTION OF THE EMBODIMENTS

Specific embodiments of the present disclosure will be disclosed herein as required. However, it should be understood that the embodiments disclosed herein are merely typical examples of the present disclosure, which may be embodied in various forms. Therefore, specific details disclosed herein are not to be regarded as limiting, but merely as a basis for the claims and as a representative basis for teaching one skilled in the art to variously employ the present disclosure in any suitable manner, including adopting various features disclosed herein and combining them with features that may not be expressly disclosed herein.

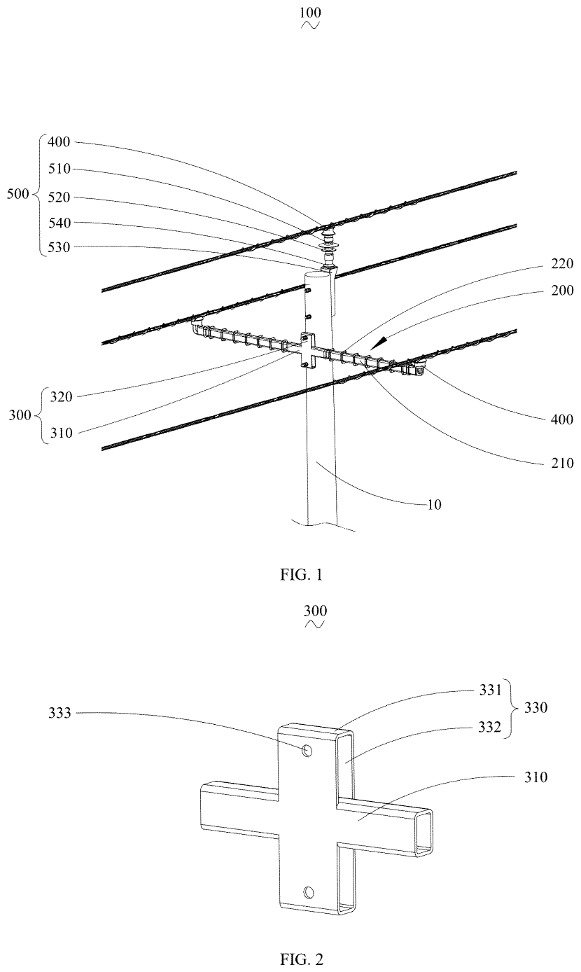

Referring to FIG. 1, the present disclosure provides a power transmission pole 100, which includes a pole 10 and a composite crossarm fixed on the pole 10. The composite crossarm is configured to attach conducting wires. The composite crossarm includes a first crossarm 200. The first crossarm 200 is fixed on the pole 10 in a horizontal direction. The first crossarm 200 includes a first rod 210 (which is marked in the figure for illustration only), an intermediate fitting 300, two wire-attaching fittings 400, and a first insulating layer 220. The intermediate fitting 300 is a cross-shaped fitting. The intermediate fitting 300 is fixedly connected to a middle portion of the first rod 210, for fixing the first crossarm 200 on the pole 10. The two wire-attaching fittings 400 are respectively connected to two ends of the first rod 210, for attaching conducting wires. The first insulating layer 220 covers at least part of an outer periphery of the first rod 210. The first crossarm 200 has a simple overall structure and reliable strength, and is directly fixed on the pole 10 through the intermediate fitting 300, without drilling holes in the first rod 210, which avoids affecting the mechanical properties of the first rod 210. Moreover, the first insulating layer 220 on the outer periphery of the first rod 210 may not be worn due to long-term stress, thereby ensuring the mechanical properties and load-bearing capacity of the first crossarm 200 and prolonging the service life.

The first rod 210 is made of a composite material, for example, formed by pultruding glass fiber or aramid fiber impregnated with epoxy resin. Compared with the metal material used to make a conventional crossarm, the composite material is more corrosion-resistant, low-cost, and can realize significant weight reduction, facilitating the mounting of the first crossarm 200. In this embodiment, a cross section of the first rod 210 is square-shaped. In other embodiments, the cross section of the first rod can also be circular-shaped, T-shaped, or I-shaped, and which is not limited herein.

The first insulating layer 220 covers at least part of the outer periphery of the first rod 210 including a sheath and sheds that are spaced on the sheath. That is, the first insulating layer 220 is located on the portions of the outer periphery of the first rod 210 other than the portions on which the intermediate fitting 300 and the wire-attaching fittings 400 are located. Sealing connections are adopted between the first insulating layer 220 and the intermediate fitting 300, and between the first insulating layer 220 and the wire-attaching fittings 400, to protect the first rod 210 and prevent the first rod 210 from aging. The first insulating layer 220 is made of high-temperature vulcanized silicone rubber. The silicone rubber material is integrally injected to cover the outer periphery of the first rod 210, which has low cost and high efficiency. Certainly, the covering method can also be a molding process, so that the insulating layer made of high-temperature vulcanized silicone rubber may be formed integrally. The silicone rubber material has good aging resistance and hydrophobic migration properties, which can reduce the probability of pollution flashover and rain flashover and improve the safety and reliability of the first crossarm 200.

The intermediate fitting 300 includes an intermediate sleeve 310 and a pole connecting member 320 that are integrally connected to each other. The intermediate sleeve 310 has a hollow tube structure and is used to fit over and be fixed on an outer periphery of the first rod 210. The intermediate sleeve 310 fits over the middle portion of the first rod 210. The pole connecting member 320 is vertically connected to the intermediate sleeve 310, and configured to fix the first crossarm 200 to the pole 10. An inner wall of the intermediate sleeve 310 is shaped and sized to match the cross section of the first rod 210, that is, in this embodiment, the intermediate sleeve 310 is formed as a square tube, so that the contact area between the first rod 210 and the intermediate sleeve 310 can be increased, making the connection between the first rod 210 and the intermediate sleeve 310 more stable, and improving the mechanical properties of the first crossarm 200. In other embodiments, the cross-sectional shape of the intermediate sleeve can also be circular, T-shaped, or I-shaped, as long as the intermediate sleeve can match the cross-sectional shape of the first rod, and which is not limited herein.

Referring to FIGS. 1 to 2, in an embodiment, the pole connecting member 320 includes two first connecting members 330. The two first connecting members 330 are vertically connected in a middle portion of the intermediate sleeve 310, and are respectively located on two sides of the intermediate sleeve 310 in a direction perpendicular to an axial direction of the intermediate sleeve 310, and the first connecting member 330 is configured to be connected to the pole 10.

The first connecting member 330 includes a first plate member 331 and two second plate members 332. Two ends of the first plate member 331 are vertically connected to first ends of the two second plate members 332 respectively. The two second plate members 332 extend from the two ends of the first plate member 331 in the same direction away from the first plate member 331. Second ends of the two second plate members 332 not connected to the first plate member 331 are vertically connected to the intermediate sleeve 310. The first plate member 331 and the two second plate members 332 are connected by a welding process or integrally formed by a casting process, so that the manufacturing is simple, and the mechanical strength of the first connecting member 330 can be ensured. The two second plate members 332 are provided with first connecting holes 333 respectively. The two first connecting holes 333 are coaxially arranged, and extending directions of the two first connecting holes 333 are perpendicular to surfaces of the second plate members 332 respectively. The pole 10 is provided with first mounting holes (not shown) corresponding to the first connecting holes 333.

The intermediate sleeve 310 and the pole connecting member 320 can be made of metal (for example, iron, steel, aluminum, etc.), which is easy to obtain and low in cost. The intermediate sleeve 310 and the pole connecting member 320 are connected to each other by a welding process or integrally formed by a casting process, so that the manufacturing is simple, and the connection strength between the intermediate sleeve 310 and the pole connecting member 320 can be ensured.

When assembling the first crossarm 200, the intermediate sleeve 310 of the intermediate fitting 300 is arranged to fit over the middle portion of the first rod 210, and then, the two wire-attaching fittings 400 are arranged to fit over the two ends the first rod 210; and the fixation of the intermediate sleeve 310 and the wire-attaching fittings 400 on the first rod 210 is realized by crimping. Certainly, the fixation can also be realized by glue binding, as long as the intermediate sleeve 310 and the wire-attaching fittings 400 can be firmly connected to the first rod 210. Then, the first insulating layer 220 is formed in the areas of the first rod 210 not covered by the intermediate sleeve 310 and the wire-attaching fittings 400. For example, silicone rubber sheds can be formed by vacuum integral injection. In this way, the first crossarm 200 can be assembled.

When mounting the first crossarm 200 on the pole 10, the intermediate sleeve 310 is arranged close to the pole 10 in the horizontal direction, and the two first connecting members 330 are placed in the vertical direction and are respectively located at the upper and lower sides of the intermediate sleeve 310. Fasteners such as bolts extend through the first connecting holes 333 on the two second plate members 332 of the first connecting member 330 and the corresponding first mounting holes on the pole 10, to fix the first connecting member 330 onto the pole 10, thereby fixing the first crossarm 200 onto the pole 10. The mounting is simple and efficient.

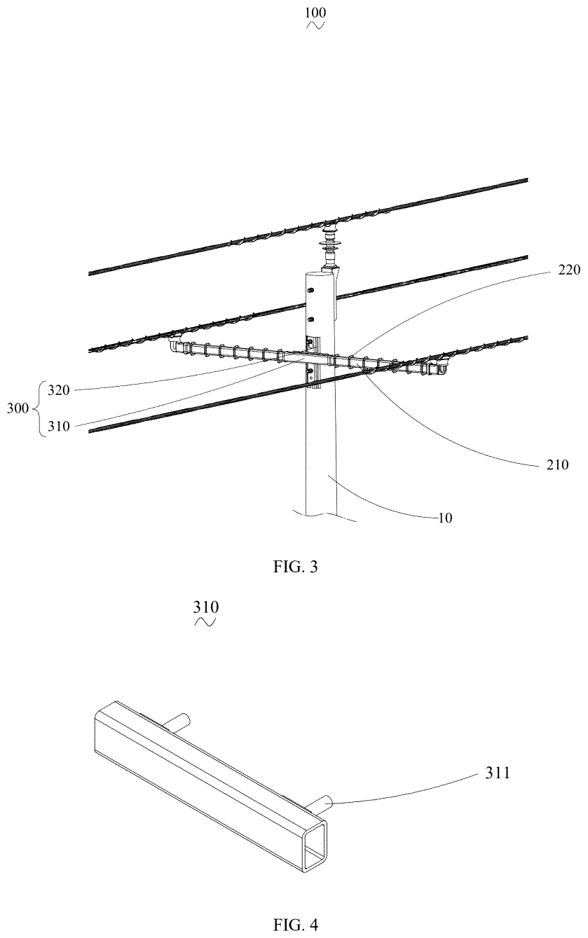

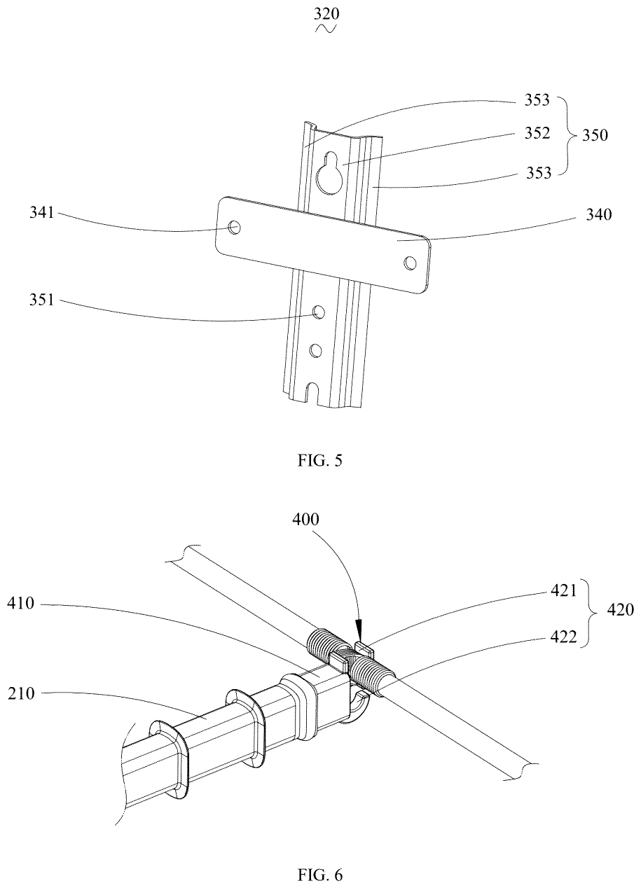

Referring to FIGS. 3 to 5, in another embodiment, the intermediate fitting 300 includes an intermediate sleeve 310 and a pole connecting member 320 that are fixedly connected to each other. The intermediate sleeve 310 and the pole connecting member 320 are provided separately. A side of the intermediate sleeve 310 adjacent to the pole 10 is connected to at least two threaded rods 311. The two threaded rods 311 are arranged in parallel and at an interval at two ends of the side of the intermediate sleeve 310 adjacent to the pole 10. Axes of the two threaded rods 311 and an axis of the intermediate sleeve 310 are located in the same horizontal plane and are perpendicular to each other.

The pole connecting member 320 includes a third plate member 340 and a fourth plate member 350 that are vertically connected to each other. The third plate member 340 is a rectangular plate. The third plate member 340 is provided with at least two second connecting holes 341, for fitting connection with the threaded rods 311. The fourth plate member 350 is provided with a plurality of third connecting holes 351, for connecting the pole 10. The pole 10 is provided with second mounting holes (not shown) corresponding to the third connecting holes 351.

In this embodiment, a cross-section of the pole 10 is circular. Correspondingly, the fourth plate member 350 includes a body connecting member 352 and two connecting lugs 353 having the same length as the body connecting member 352. A cross-section of the body connecting member 352 is roughly U-shaped. The body connecting member 352 is provided with a plurality of third connecting holes 351. The two connecting lugs 353 are symmetrically connected to two sides of the body connecting member 352 at a certain angle, respectively, so that a cross section of the fourth plate member 350 is roughly Ω-shaped, and the two connecting lugs 353 can be used to match the curvature of an outer periphery of the pole 10 to increase the contact area between the fourth plate member 350 and the pole 10, thereby improving the connection strength between the fourth plate member 350 and the pole 10. In addition, when the fourth plate member 350 is mounted on the pole 10, the two connecting lugs 353 are attached to the pole 10 tightly. In this case, there is a certain space between the body connecting member 352 with the U-shaped structure and the outer periphery of the pole 10, which can provide sufficient mounting margin and improve mounting convenience.

In this embodiment, the plurality of third connecting holes 351 on the fourth plate member 350 are distributed on the upper and lower sides of the third plate member 340, so that the connection between the fourth plate member 350 and the pole 10 is more stable. In other embodiments, the number and positions of the third connecting holes can be adjusted according to the mounting requirements of the first crossarm, and which are not specifically limited herein.

The intermediate sleeve 310 and the pole connecting member 320 can be made of metal (for example, iron, steel, aluminum, etc.), which is easy to obtain and low in cost. The intermediate sleeve 310 and the threaded rods 311 are connected by a welding process or integrally formed by a casting process, so that the manufacturing is simple, and the connection strength between the intermediate sleeve 310 and the threaded rods 311 can be ensured. The third plate member 340 and the fourth plate member 350 of the pole connecting member 320 are connected by a welding process, resulting in simple manufacturing and high connection strength.

When mounting the first crossarm 200 on the pole 10, the pole connecting member 320 is attached to the pole 10 tightly, and the third plate member 340 is arranged in the horizontal direction, then the fourth plate member 350 is arranged in the vertical direction; and the two threaded rods 311 respectively extend through the two second connecting holes 341 on the third plate member 340, and cooperate with fasteners such as nuts to realize a fixed connection, so that the assembly of the intermediate sleeve 310 and the pole connecting member 320 can be realized, thereby achieving the assembly of the first crossarm 200. Then, fasteners such as bolts extend through the third connecting holes 351 on the fourth plate member 350 of the pole connecting member 320 and the corresponding second mounting holes on the pole 10 to fix the pole connecting member 320 onto the pole 10, thereby fixing the first crossarm 200 on the pole 10. The mounting is simple and efficient.

Further, in order to improve the mounting convenience of the first crossarm 200, the third connecting hole 351 of the fourth plate member 350 located above the third plate member 340 can be a combination hole. The combination hole is formed by partially intersecting a circular hole with a U-shaped hole. The diameter of the circular hole is larger than the width of the U-shaped hole, so that when the fourth plate member 350 is connected to the pole 10, a fastener such as a bolt can be screwed into the pole 10 firstly, and then the fourth plate member 350 is attached and fixed onto the bolt. That is, a head of the bolt extends through the circular hole having a slightly larger size of the combination hole, and then a rod portion of the bolt is engaged into the U-shaped hole having a slightly smaller size of the combination hole. In this way, the pole connecting member 320 can be pre-fixed on the pole 10 through simple attaching operations, which facilitates the mounting of the first crossarm 200 and further improves the mounting efficiency.

Referring to FIGS. 6 to 9, the wire-attaching fitting 400 includes an end sleeve 410 and a groove structure 420 that are connected to each other. A first end of the end sleeve 410 is connected to the end of the first rod 210, and a second end of the end sleeve 410 is connected to the groove structure 420. An inner wall of the end sleeve 410 is shaped and sized to be adapted to the cross section of the first rod 210. The end sleeve 410 can be connected to the first rod 210 through a crimping process. The groove structure 420 is configured for attaching a conducting wire.

The wire-attaching fitting 400 can be made of metal (for example, iron, steel, aluminum, etc.), which is easy to obtain and low in cost. The end sleeve 410 and the groove structure 420 are connected to each other by a welding process or integrally formed by a casting process, so that the manufacturing is simple, and the connection strength between the end sleeve 410 and the groove structure 420 can be ensured.

Referring to FIG. 6, in an embodiment, the wire-attaching fitting 400 is a deep-groove-type fitting, including an end sleeve 410 and a groove structure 420 that are connected to each other. The groove structure 420 includes a first groove 421 and a lifting part 422 that are arranged in an up-and-down sequence. The first groove 421 is a U-shaped groove for receiving the conducting wire. A groove opening of the first groove 421 is open upward. The lifting part 422 is a C-shaped groove for meeting the lifting requirements, that is, for lifting and mounting the first crossarm 200 by a tool such as a rope. A groove opening of the lifting part 422 is open outward away from the first rod 210. The size of the arc portion of the bottom of the first groove 421 is adapted to the outer diameter of the conducting wire. The depth of the first groove 421 is greater than the outer diameter of the conducting wire placed in the first groove 421, so that the conducting wire can be firmly fixed at the bottom of the first groove 421, which can prevent the conducting wire from slipping off and deviating, and can effectively prevent the conducting wire from being worn due to stress and prolong the service life of the conducting wire. The conducting wire can be fixed in the first groove 421 by binding with a binding strap or other methods. The lifting part 422 can also be used as a threading opening for the binding strap fixing the conducting wire. The C-shaped groove structure can play a limiting role for the binding strap inserted into the lifting part 422, effectively preventing the binding strap from falling off outwards and ensuring that the first groove 421 can securely attach the conducting wire. The widths of the first groove 421 and the lifting part 422 in an extending direction of the conducting wire are both less than the width of the end sleeve 410, which can reduce the weight of the wire-attaching fitting 400 while ensuring the wire-attaching effect, and reduce the cost.

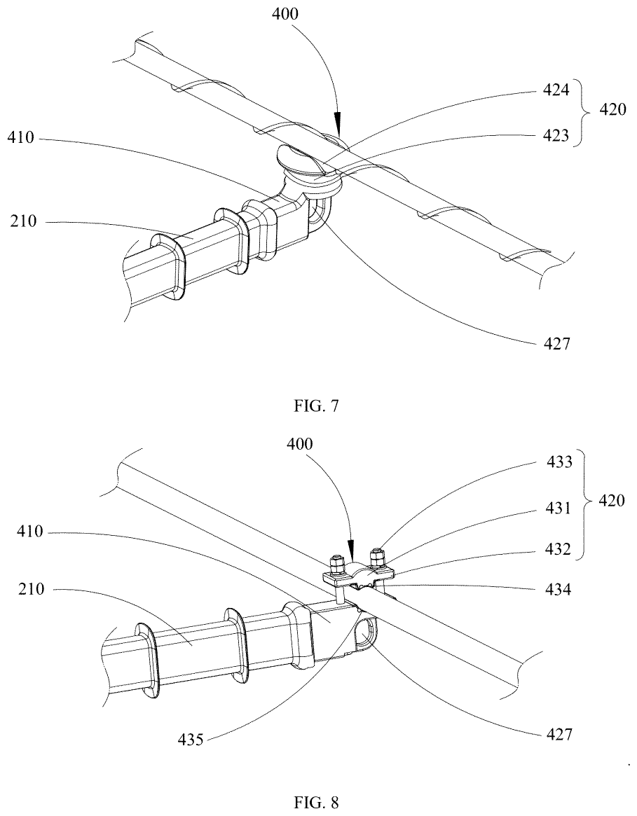

Referring to FIG. 7, in another embodiment, the wire-attaching fitting 400 is a top-groove type fitting, including an end sleeve 410 and a groove structure 420 that are connected to each other. A top surface of the groove structure 420 is provided with a first groove 424. The first groove 424 is an arc-shaped groove for receiving a conducting wire. An extending direction of the first groove 424 is perpendicular to the axial direction of the first rod 210. The conducting wire can be fixed in the first groove 424 by binding with a binding strap, etc. A groove body of the first groove 424 is a concave semi-cylindrical surface, which can increase the contact area between the first groove 424 and the conducting wire, so that the conducting wire can be stably attached in the first groove 424. A second groove 423 is circumferentially provided on a sidewall of the groove structure 420. The second groove 423 is an arc-shaped groove and is used to assist in fixing the conducting wire. That is, the binding strap for fixing the conducting wire can be wrapped around the second groove 423 to prevent the binding strap from slipping off to cause the deviation of the conducting wire, ensuring the stable attachment of the conducting wire. A lifting part 427 is provided on the bottom of the groove structure 420. The lifting part 427 is provided with a hook hole to meet the lifting requirements, that is, which is used to lift and mount the first crossarm 200 through a tool such as a rope. The width of the lifting part 427 in the extending direction of the conducting wire is less than the width of the end sleeve 410, which can reduce the weight of the wire-attaching fitting 400 while ensuring the wire-attaching effect, and reduce the cost.

Referring to FIG. 8, in a further embodiment, the wire-attaching fitting 400 is a cover-type fitting, including an end sleeve 410 and a groove structure 420 that are connected to each other. The groove structure 420 includes a cover 431, a tab 432, fasteners 433, and a first groove base 435. The first groove base 435 is provided with a first groove that is adapted to the outer diameter of the conducting wire, so as to receive the conducting wire. A second groove 434 is provided on the bottom of the cover 431. The second groove 434 is an arc-shaped groove, and configured to assist in fixing the conducting wire. The first groove and the second groove 434 are arranged in directions perpendicular to the axial direction of the first rod 210, so that the conducting wire can be placed more firmly after cooperation. The cover 431 extends towards two sides in the axial direction of the first rod 210 to form two tabs 432. The tabs 432 can be integrally formed with the cover 431, or the tabs 432 can be welded or bonded to the cover 431. The tabs 432 and the first groove base 435 are connected to each other through the fasteners 433, so that the cover 431 is pressed against and fixes the conducting wire. Specifically, each of the fasteners 433 includes a screw rod and a nut that cooperate with each other. The first groove base 435 is provided with screw holes that match the screw rods, and the tabs 432 are provided with through holes that match the screw holes respectively. When mounting the conducting wire, the conducting wire is placed into the first groove on the first groove base 435, then placing the cover 431 above the conducting wire, so the second groove 434 of the cover 431 is fitted onto the top of the conducting wire and is pressed against the conducting wire. Then, the screw rods extend through the through holes on the tabs 432 and are tightened into the screw holes on the first groove base 435, so that the cover 431 is fixedly connected to the first groove base 435, thereby stably attaching the conducting wire in the first groove. The bottom of the groove structure 420 is provided with a lifting part 427. The lifting part 427 has the same structure and functions as those described above, and which will not be repeatedly described here again.

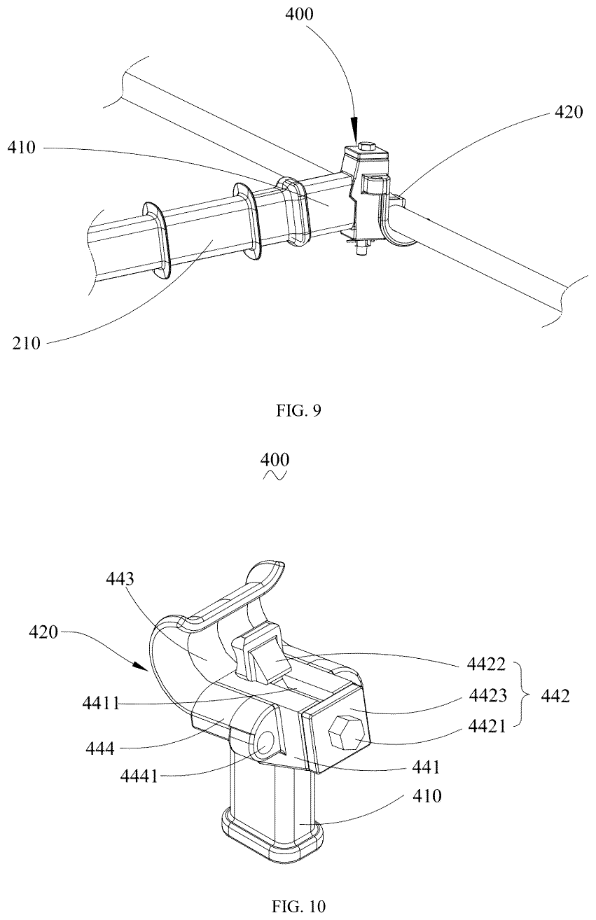

Referring to FIGS. 9 to 11, in another embodiment, the wire-attaching fitting 400 is an engaging-groove-type fitting, including an end sleeve 410 and a groove structure 420 that are connected to each other. The groove structure 420 includes a support block 441, a locking component 442, and a first groove 443. A first end of the support block 441 is connected to a second end of the end sleeve 410. A longitudinal axial direction (or called the longitudinal central axis direction) of the support block 441 is arranged perpendicular to the axial direction of the end sleeve 410. One end of the first groove 443 is connected to a second end of the support block 441. Specifically, the one end of the first groove 443 is connected to a side of the second end of the support block 441. A plane where an opening of the first groove 443 is located is perpendicular to the longitudinal axial direction of the support block 441. That is, the plane where the opening of the first groove 443 is located is parallel to the axial direction of the end sleeve 410. The locking component 442 is arranged on the support block 441, and configured to fix a conducting wire in the first groove 443. When the wire-attaching fitting 400 of the first crossarm 200 adopts the engaging-groove-type fitting, the axial direction of the end sleeve 410 is arranged horizontally, so that the plane where the opening of the first groove 443 is located in a horizontal plane. That is, the bottom of the first groove 443 is arranged horizontally to attach the conducting wire. When the wire-attaching fitting 400 of the second crossarm 500 adopts the engaging-groove-type fitting, the axial direction of the end sleeve 410 is arranged vertically, so that the plane where the opening of the first groove 443 is located is also arranged vertically. That is, the bottom of the first groove 443 is arranged vertically to attach the conducting wire.

The second end of the support block 441 is provided with an adjustable groove 4411. That is, the side of the support block 441 away from the end sleeve 410 is provided with the adjustable groove 4411, which is configured to cooperate with the locking component 442 to fix the conducting wire. The locking component 442 includes a locking bolt 4421, a locking member 4422, a locking plate 4423, and a locking nut. The locking member 4422 is arranged in the adjustable groove 4411 and can move along the adjustable groove 4411 to adjust its position, and is configured to clamp the conducting wire. The locking plate 4423 is arranged at the end of the support block 441 to cover one end of the adjustable groove 4411. The locking bolt 4421 extends through the locking plate 4423 and the locking member 4422, and extends out of another end of the adjustable groove 4411, and then is fixed in the adjustable groove 4411 through the locking nut. The locking member 4422 can be moved along the locking bolt 4421 and perform locking, thereby fixing the conducting wire between the locking member 4422 and the first groove 443.

The locking member 4422 includes a moving block 44221 and a limiting block 44222 that are connected to each other. The moving block 44221 is arranged in the adjustable groove 4411. The moving block 44221 is provided with a moving hole 44224 extending therethrough. The locking bolt 4421 extends through the moving hole 44224. An inner surface of the moving hole 44224 and an outer surface of the locking bolt 4421 are provided with matching threads, so that the locking member 4422 can move along the locking bolt 4421 and is locked by the locking nut. The limiting block 44222 is connected onto the outer periphery of the moving block 44221. A side surface of the limiting block 44222 adjacent to the conducting wire is an arc surface. The arc surface can increase the contact area between the limiting block 44222 and the conducting wire, so that the conducting wire is firmly clamped between the locking member 4422 and the first groove 443. Further, the locking member 4422 further includes a reinforcing block 44223. The reinforcing block 44223 has a triangular block structure and is connected to the moving block 44221 and the limiting block 44222 at the same time, thereby improving the overall strength of the locking member 4422. After the locking component 442 is mounted to fix the conducting wire, the bottom surface of the reinforcing block 44223 abuts against two sides of the adjustable groove 4411, which can further limit the relative position of the locking member 4422 and the adjustable groove 4411, and prevent the locking member 4422 from loosening due to shaking of the conducting wire when the conducting wire is subjected to external forces such as wind load.

The first groove 443 is a C-shaped groove. The C-shaped groove is a semi-cylindrical groove. Two sides of the C-shaped groove have outwardly expanded arc-shaped structures, and a distance between the two sides gradually increases. That is, when drawing imaginary circles at different positions of the C-shaped groove, the diameters of the two sides of the C-shaped groove are greater than the diameter of the middle portion of the C-shaped groove. Such structure can not only be used to attach a straight conducting wire in power transmission lines, but also can be used to attach a conducting wire curved at the corners of the power transmission lines, resulting in a wider range of applications.

When attaching the conducting wire, firstly, the conducting wire is placed in the first groove 443, and then the relative position of the locking member 4422 and the locking bolt 4421 is adjusted according to the specifications of the conducting wire, so that the limiting block 44222 of the locking member 4422 abuts against the conducting wire. Then the locking bolt 4421 is fixedly connected to the support block 441 through the locking nut, thereby firmly clamping the conducting wire between the locking member 4422 and the first groove 443. By fixing the conducting wire in this way, the operation is simple, the conducting wire hanging is more flexible, and conducting wires of different specifications can be attached, so the application range is wider.

Further, the support block 441 is connected to two lifting parts 444 respectively arranged on two sides in a direction perpendicular to the axial direction of the support block 441. The lifting parts 444 have a semi-cylindrical structure. Central axes of the two lifting parts 444 are parallel to the axis of the locking bolt 4421 and the longitudinal axial direction of the support block 441 respectively. Each lifting part 444 is provided with a through hole 4441 along its central axis, which can be configured to lift and mount the first crossarm 200 through a tool such as a rope. Two through holes 4441 of the two lifting parts 444 can also cooperate with each other to be connected to electrical components such as adapters.

Continuing to refer to FIG. 1, the composite crossarm further includes a second crossarm 500. The second crossarm 500 is fixed on the pole 10 in the vertical direction and is located above the first crossarm 200. The first crossarm 200 and the second crossarm 500 are separated from each other. The second crossarm 500 is fixed on the pole 10 through a fixing bracket 530. The second crossarm 500 includes a second rod 510 (the marks in the figure are for illustration only), a second insulating layer 520, a wire-attaching fitting 400, and a bottom connecting fitting 540. The second insulating layer 520 covers at least part of the outer circumferential surface of the second rod 510. The wire-attaching fitting 400 is connected to the top end of the second rod 510, which is the same as the wire-attaching fitting 400 of the first crossarm 200, and is configured to fix a conducting wire. The bottom connecting fitting 540 is connected to the bottom end of the second rod 510, and is configured to fix the second crossarm 500 on the fixing bracket 530. The first crossarm 200 and the second crossarm 500 are both provided so that the composite crossarm can be used for attaching single-circuit three-phase power transmission conducting wires. In other embodiments, the composite crossarm may also include only three first crossarms, so that the composite crossarm can be used for attaching dual-circuit six-phase power transmission conducting wires. The three first crossarms are arranged in parallel on the pole at intervals in the vertical direction. The wire-attaching fittings at both ends of each first crossarm can be used to attach the power transmission conducting wire, thus forming six wire-attaching points to meet the dual-circuit power transmission needs.

The second rod 510 is made of a composite material, for example, is formed by pultruding glass fiber or aramid fiber impregnated with epoxy resin. Compared with the metal material used to make a conventional crossarm, the composite material is more corrosion-resistant and low-cost, and can reduce the weight of the second crossarm 500. In this embodiment, a cross section of the second rod 510 is circular. In other embodiments, the cross section of the second rod can also be square, T-shaped, I-shaped, etc., which is not limited herein.

The second insulating layer 520 covers the second rod 510, and includes a sheath and sheds that are spaced on the sheath. That is, the second insulating layer 520 is located on the portions of the outer periphery of the second rod 510 other than the portions on which the wire-attaching fitting 400 and the bottom connecting fitting 540 are located. Sealing connections are adopted between the second insulating layer 520 and the wire-attaching fitting 400, and between the second insulating layer 520 and the bottom connecting fitting 540, to protect the second rod 510 and prevent the second rod 510 from aging. The second insulating layer 520 is made of high-temperature vulcanized silicone rubber. The silicone rubber material is integrally injected to cover the outer periphery of the second rod 510, which has low cost and high efficiency. Certainly, the covering method can also be a molding process, so that the insulating layer made of silicone rubber may be formed integrally. The silicone rubber material has good aging resistance and hydrophobic migration properties, which can reduce the probability of pollution flashover and rain flashover, and improve the safety and reliability of the second crossarm 500.

The bottom connecting fitting 540 includes a bottom sleeve and a base that are connected to each other. The bottom sleeve is configured to fit over and be fixed on the outer periphery of the second rod 510. An inner wall of the bottom sleeve is shaped and sized to match the cross section of the second rod 510. The bottom sleeve and the second rod 510 are connected to each other through a crimping process. The base is provided with a bottom connecting hole (not shown), which is configured for connecting the fixing bracket 530.

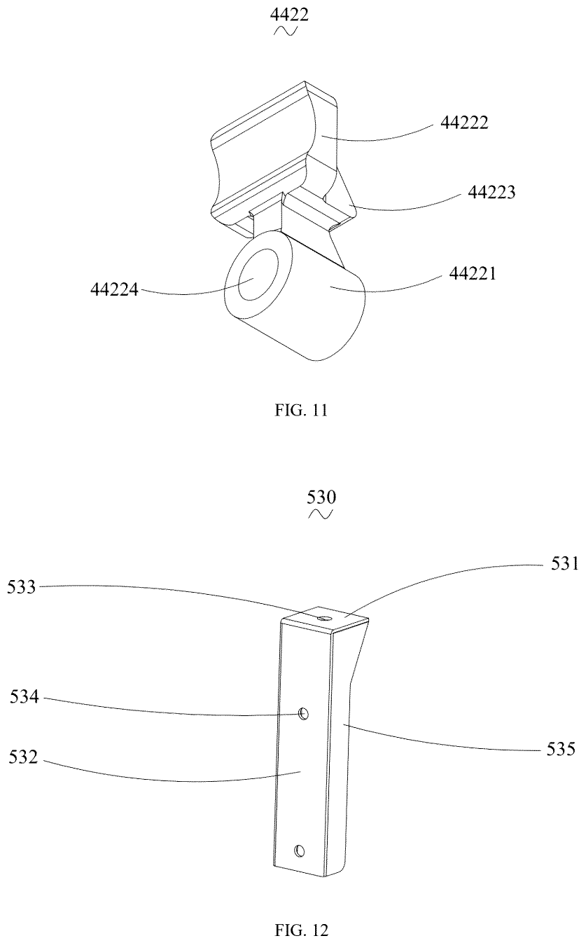

Referring to FIG. 12, the fixing bracket 530 includes a first connecting part 531 and a second connecting part 532. The first connecting part 531 and the second connecting part 532 are integrally formed by a casting process or connected to each other by a welding process, so that the manufacturing is simple, and the connection strength between the first connecting part 531 and the second connecting part 532 can be ensured. The fixing bracket 530 can be made of metal (for example, iron, steel, aluminum, etc.), which is easy to obtain and low in cost. The first connecting part 531 includes a horizontal plate member, which is used to connect the second crossarm 500 so that the second crossarm 500 can be fixed on an upper part of the pole 10 in the vertical direction. The horizontal plate member of the first connecting part 531 is provided with a fourth connecting hole 533. The fourth connecting hole 533 corresponds to a bottom connecting hole on the bottom connection fitting 540 of the second crossarm 500. A fastener such as a bolt is inserted into the fourth connecting hole 533 and the corresponding bottom connecting hole to fix the bottom connecting fitting 540 on the fixing bracket 530, thereby fixing the second crossarm 500 on the fixing bracket 530, which is easy to mount, efficient. The second connecting part 532 includes a vertical plate member, which is vertically connected to the horizontal plate member. The vertical plate member is provided with a plurality of fifth connecting holes 534, which are configured for connecting the pole 10. The pole 10 is provided with third mounting holes (not shown) corresponding to the fifth connecting holes 534. Fasteners such as bolts are inserted into the fifth connecting holes 534 on the vertical plate member of the fixing bracket 530 and the corresponding third mounting holes on the pole 10, to fix the fixing bracket 530 on the pole 10, thereby fixing the second crossarm 500 on the pole 10. The mounting is simple and efficient. Further, a plurality of reinforcing members 535 can be provided between the horizontal plate member of the first connecting part 531 and the vertical plate member of the second connecting part 532. The reinforcing members are connected to both the horizontal plate member and the vertical plate member, so that the overall mechanical strength of the fixing bracket 530 can be improved, thereby ensuring a reliable connection between the second crossarm 500 and the pole 10.

The composite crossarm according to the present disclosure includes the first crossarm 200 and the second crossarm 500 that are separated from each other. The first crossarm 200 is arranged horizontally. Two-phase conducting wires are attached at two ends of the first crossarm 200. The second crossarm 500 is arranged vertically. A one-phase conducting wire is attached to the top end of the second crossarm 500, so that the composite crossarm can be used for the construction of single-circuit three-phase power transmission conducting wires. The composite crossarm has a simple overall structure, reliable strength, convenient mounting, and low manufacturing cost. In addition, when the intermediate fitting 300 of the first crossarm 200 of the present disclosure is connected to the first rod 210, it is not necessary to drill holes in the first rod 210, which ensures the mechanical properties and load-bearing capacity of the composite crossarm, prolongs the service life of the composite crossarm, and reduces the overall cost.

The technical content and technical features of the present disclosure have been disclosed as above. However, it should be understood that under the creative thinking of the present disclosure, those skilled in the art can make various changes and improvements to the above structures and materials, including those separately disclosed or claimed here, obviously including other combinations of these features. These modifications and/or combinations all fall within the technical field involved in the present disclosure and within the protection scope of the claims of the present disclosure.

1. A composite crossarm configured to be fixed on a pole to attach a conducting wire, wherein the composite crossarm comprises a first crossarm comprising:
a first rod;
an intermediate fitting being a cross-shaped fitting, the intermediate fitting being connected to a middle portion of the first rod and configured to fix the first crossarm on the pole;
two wire-attaching fittings respectively connected to two ends of the first rod, and configured to attach the conducting wire; and
a first insulating layer covering at least part of an outer periphery of the first rod.

2. The composite crossarm according to claim 1, wherein the composite crossarm further comprises a second crossarm, wherein the first crossarm is fixed on the pole in a horizontal direction; the second crossarm is fixed on the pole in a vertical direction and is located above the first crossarm; and the first crossarm and the second crossarm are separated from each other.

3. The composite crossarm according to claim 1, wherein the intermediate fitting comprises an intermediate sleeve and a pole connecting member that are connected to each other, the intermediate sleeve fitting over the middle portion of the first rod, the pole connecting member being vertically connected to the intermediate sleeve, and configured to fix the first crossarm to the pole.

4. The composite crossarm according to claim 3, wherein an inner wall of the intermediate sleeve is shaped and sized to match a cross section of the first rod.

5. The composite crossarm according to claim 3, wherein a side of the intermediate sleeve adjacent to the pole is connected to at least two threaded rods; the pole connecting member comprises a third plate member and a fourth plate member that are vertically connected to each other; wherein the third plate member is provided with at least two second connecting holes;
and the threaded rods cooperate with the second connecting holes to connect the intermediate sleeve and the pole connecting member, and wherein the fourth plate member is provided with a plurality of third connecting holes and configured to be connected to the pole.

6. The composite crossarm according to claim 5, wherein the intermediate sleeve and the threaded rods are connected to each other by a welding process or integrally formed by a casting process; and the third plate member and the fourth plate member are connected by a welding process.

7. The composite crossarm according to claim 1, wherein the wire-attaching fitting comprises an end sleeve and a groove structure that are connected to each other; the end sleeve is configured to be connected to an end of the first rod; and the groove structure is configured to attach the conducting wire.

8. The composite crossarm according to claim 7, wherein a first groove is provided on a top surface of the groove structure, and configured to receive the conducting wire; a second groove is circumferentially provided on a sidewall of the groove structure, and configured to assist in fixing the conducting wire; and a lifting part is provided on a bottom of the groove structure, and configured to lift and mount the first crossarm.

9. The composite crossarm according to claim 1, wherein a cross section of the first rod is square.

10. The composite crossarm according to claim 1, wherein the first rod is formed by pultruding glass fiber or aramid fiber impregnated with epoxy resin.

11. The composite crossarm according to claim 5, wherein the fourth plate member comprises a body connecting member and two connecting lugs having a same length as the body connecting member; and the two connecting lugs are symmetrically connected to two sides of the body connecting member at a certain angle, to match a curvature of an outer periphery of the pole.

12. The composite crossarm according to claim 5, wherein the third connecting hole of the fourth plate member located above the third plate member is a combination hole; and wherein the combination hole is formed by partially intersecting a circular hole with a U-shaped hole, and a diameter of the circular hole is greater than a width of the U-shaped hole.
